(19) United States
(12) Patent Application Publication
(10) Pub. No.: US 2006/0063677 A1
(43) Pub. Date: Mar. 23, 2006

(54) Herbicidal composition

(76) Inventor: Georg Rudiger Kotzian, Basel (CH)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/535,685

(22) PCT Filed: Nov. 20, 2003
(86) PCT No.: PCT/EP03/13017

§ 371 Date: May 19, 2005

(30) Foreign Application Priority Data
Nov. 21, 2002 (CH) 1956/02

(51) Int. Cl. A01N 43/40; A01N 43/60

(52) U.S. Cl. 504/130; 504/136

(57) ABSTRACT

A herbicidal synergistic composition which, in addition to comprising customary inert formulation adjuvants, comprises as active ingredient a mixture of a) the compound metamifop, and b) a synergistically effective amount of at least one compound selected from the compounds of the group mesotrione, sulcotrione, isoxaflutole, pyrazoxyfen, pyrazolynate, benzofenap, sulfentrazone, pyraflufen-ethyl, beflubutamid, cafenstrole, dimethametryn, clomeprop, prometryn, cinosulfuron, triasulfuron, prosulfuron, imazosulfuron, ethoxysulfuron, sulfosulfuron, iodosulfuron, tritosulfuron, mesosulfuron, trifloxysulfuron and N-[(4,6-dimethoxypyrimidin-2-yl)aminocarbonyl]-2-(2-fluoro-1-methoxy-acetoxy-n-propyl)pyridine-3-sulfonamide, (bentazone and trifloxysulfuron), (bentazone and ethoxysulfuron), (bentazone and mesosulfuron), (bentazone and N-[(4,6-dimethoxypyrimidin-2-yl)aminocarbonyl]-2-(2-fluoro-1-methoxy-acetoxy-n-propyl)pyridine-3-sulfonamide), (simetryn and cinosulfuron), (simetryn and triasulfuron), (simetryn and prosulfuron), (simetryn and trifloxysulfuron), (simetryn and imazosulfuron), (simetryn and ethoxysulfuron), (simetryn and sulfosulfuron), (simetryn and iodosulfuron), (simetryn and mesosulfuron), (simetryn and tritosulfuron), (simetryn and N-[(4,6-dimethoxypyrimidin-2-yl)aminocarbonyl]-2-(2-fluoro-1-methoxy-acetoxy-n-propyl)pyridine-3-sulfonamide) and (metamifop and clodinafop and 2,4-D), the two-component mixture of metamifop with benzobicyclon being excluded.

The present invention relates to a novel herbicidal synergistic composition comprising a herbicidal active ingredient combination that is suitable for the selective control of weeds in crops of useful plants, for example in crops of rice.

The invention relates also to a method of controlling weeds in crops of useful plants and to the use of the novel composition for that purpose.

The compounds mesotrione (500), sulcotrione (664), isoxaflutole (436), pyrazoxyfen (666), pyrazolynate (663), benzofenap (71), sulfentrazone (711), pyraflufen-ethyl (662), beflubutamid (57), cafenstrole (108), dimethametryn (253), clomeprop (160), prometryn (641), cinosulfuron (154), triasulfuron (773), prosulfuron (657), imazosulfuron (444), ethoxysulfuron (307), sulfosulfuron (714), iodosulfuron (454), benzobicyclon (70), bentazone (69), simetryn (699), bensulfuron (66), pyrazosulfuron (665), metsulfuron (536), azimsulfuron (45), clodinafop (156), 2,4-D (205), acetochlor (7), metolachlor (529), S-metolachlor (530), and agronomically acceptable salts thereof, exhibit herbicidal action, as is described, for example, in The Pesticide Manual, 12th Edition (BCPC), 2000.

Tritosulfuron, registered as no.142469-14-5 in CAS (Chemical Abstracts), is known from EP-A-559 814 and WO 01/24633. The herbicidal action of that compound is also described therein.

The herbicidal action of metamifop is known, for example, from WO 00/05956.

Trifloxysulfuron and its herbicidal action are described, for example, in WO 00/52006.

The compound 2-[[[[(4,6-dimethoxy-2-pyrimidinyl)amino]carbonyl]amino]sulfonyl]-4-[[(methylsulfonyl)amino]methyl]benzoic acid is known under the name mesosulfuron. Its herbicidal action is described in EP-A-559 814 and WO 01/24633.

The compound N-[(4,6-dimethoxypyrimidin-2-yl)aminocarbonyl]-2-(2-fluoro-1-methoxy-acetoxy-n-propyl)pyridine-3-sulfonamide and its herbicidal action are known from WO 02/30921.

Pyraclonil (1-(3-chloro-4,5,6,7-tetrahydropyrazolo[1,5-a]pyridin-2-yl)-5-(methyl-2-propynylamino)-1H-pyrazole-4-carbonitrile, registered as RN 158353-15-2 in CAS (Chemical Abstracts)), is known from WO 94/08999. The herbicidal action of that compound is also described therein.

Surprisingly, it has now been found that a combination of variable amounts of metamifop with at least one active ingredient from the above listing exhibits a synergistic action that is capable of controlling, both pre-emergence and post-emergence, the majority of weeds occurring especially in crops of useful plants, without appreciably damaging the useful plants.

There is therefore proposed in accordance with the present invention a novel synergistic composition for the selective control of weeds which comprises a mixture of

a) metamifop and

b) a synergistically effective amount of at least one compound selected from the compounds of the group mesotrione, sulcotrione, isoxaflutole, pyrazoxyfen, pyrazolynate, benzofenap, sulfentrazone, pyraflufen-ethyl, beflubutamid, cafenstrole, dimethametryn, clomeprop, prometryn, cinosulfuron, triasulfuron, prosulfuron, imazosulfuron, ethoxysulfuron, sulfosulfuron, iodosulfuron, tritosulfuron, mesosulfuron, trifloxysulfuron, benzobicyclon, acetochlor, metolachlor, S-metolachlor, pyraclonil and N-[(4,6-dimethoxypyrimidin-2-yl)aminocarbonyl]-2-(2-fluoro-1-methoxy-acetoxy-n-propyl)pyridine-3-sulfonamide, (bentazone and trifloxysulfuron), (bentazone and ethoxysulfuron), (bentazone and mesosulfuron), (bentazone and N-[(4,6-dimethoxypyrimidin-2-yl)aminocarbonyl]-2-(2-fluoro-1-methoxy-acetoxy-n-propyl)pyridine-3-sulfonamide), (simetryn and cinosulfuron), (simetryn and triasulfuron), (simetryn and prosulfuron), (simetryn and trifloxysulfuron), (simetryn and imazosulfuron), (simetryn and ethoxysulfuron), (simetryn and sulfosulfuron), (simetryn and iodosulfuron), (simetryn and mesosulfuron), (simetryn and tritosulfuron) and (simetryn and N-[(4,6-dimethoxypyrimidin-2-yl)aminocarbonyl]-2-(2-fluoro-1-methoxy-acetoxy-n-propyl)pyridine-3-sulfonamide) and (clodinafop and 2,4-D), the two-component mixture of metamifop with benzobicyclon being excluded.

It is extremely surprising that combinations of those active ingredients exceed the additive effect on the weeds to be controlled that is to be expected in principle and thus broaden the range of action of both active ingredients especially in two respects: firstly, the rates of application of the individual compounds are reduced while a good level of action is maintained and, secondly, the composition according to the invention achieves a high level of weed control also in those cases where the individual substances, in the low rates of application range, have become useless from the agronomic standpoint. The result is a considerable broadening of the spectrum of weeds and an additional increase in selectivity in respect of the crops of useful plants, as is necessary and desirable in the event of an unintentional overdose of active ingredient. The composition according to the invention, while retaining excellent control of weeds in crops of useful plants, also allows greater flexibility in succeeding crops.

The composition according to the invention can be used against a large number of agronomically important weeds, such as Stellaria, Nasturtium, Agrostis, Digitaria, Avena, Setaria, Sinapis, Lolium, Solanum, Bromus, Apera, Alopecurus, Matricaria, Abutilon, Sida, Xanthium, Amaranthus, Chenopodium, lpomoea, Chrysanthemum, Galium, Viola and Veronica. The composition according to the invention is suitable for all methods of application conventionally used in agriculture, e.g. pre-emergence application, post-emergence application and seed dressing. The composition according to the invention is suitable for controlling weeds in rice. “Crops of useful plants” are to be understood to mean also those which have been made tolerant to herbicides or classes of herbicides as a result of conventional methods of breeding or genetic engineering methods.

The composition according to the invention comprises the mentioned active ingredients in any mixing ratio, but usually has an excess of one component over the other. Preferred mixing ratios of the active ingredients are from 100:1 to 1:100 and 50:1 to 1:50.

Compositions that have been found to be especially effective are the combinations metamifop and sulcotrione, metamifop and isoxaflutole, metamifop and pyrazoxyfen, metamifop and pyrazolynate, metamifop and benzofenap, metamifop and sulfentrazone, metamifop and pyraflufen-ethyl, metamifop and beflubutamid, metamifop and cafenstrole, metamifop and dimethametryn, metamifop and clomeprop, metamifop and prometryn, metamifop and trifloxysulfuron, metamifop and mesotrione and cinosulfuron, metamifop and sulcotrione and cinosulfuron, metamifop and isoxaflutole and cinosulfuron, metamifop and pyrazoxyfen and cinosulfuron, metamifop and pyrazolynate and cinosulfuron, metamifop and benzofenap and cinosulfuron, metamifop and sulfentrazone and cinosulfuron, metamifop and pyraflufen-ethyl and cinosulfuron, metamifop and beflubutamid and cinosulfuron, metamifop and cafenstrole and cinosulfuron, metamifop and dimethametryn and cinosulfuron, metamifop and clomeprop and cinosulfuron, metamifop and prometryn and cinosulfuron, metamifop and trifloxysulfuron and cinosulfuron, metamifop and benzobicyclon and cinosulfuron, metamifop and mesotrione and triasulfuron, metamifop and sulcotrione and triasulfuron, metamifop and isoxaflutole and triasulfuron, metamifop and pyrazoxyfen and triasulfuron, metamifop and pyrazolynate and triasulfuron, metamifop and benzofenap and triasulfuron, metamifop and sulfentrazone and triasulfuron, metamifop and pyraflufen-ethyl and triasulfuron, metamifop and beflubutamid and triasulfuron, metamifop and cafenstrole and triasulfuron, metamifop and dimethametryn and triasulfuron, metamifop and clomeprop and triasulfuron, metamifop and prometryn and triasulfuron, metamifop and trifloxysulfuron and triasulfuron, metamifop and benzobicyclon and triasulfuron, metamifop and mesotrione and prosulfuron, metamifop and sulcotrione and prosulfuron, metamifop and isoxaflutole and prosulfuron, metamifop and pyrazoxyfen and prosulfuron, metamifop and pyrazolynate and prosulfuron, metamifop and benzofenap and prosulfuron, metamifop and sulfentrazone and prosulfuron, metamifop and pyraflufen-ethyl and prosulfuron, metamifop and beflubutamid and prosulfuron, metamifop and cafenstrole and prosulfuron, metamifop and dimethametryn and prosulfuron, metamifop and clomeprop and prosulfuron, metamifop and prometryn and prosulfuron, metamifop and trifloxysulfuron and prosulfuron, metamifop and benzobicyclon and prosulfuron, metamifop and mesotrione and trifloxysulfuron, metamifop and sulcotrione and trifloxysulfuron, metamifop and isoxaflutole and trifloxysulfuron, metamifop and pyrazoxyfen and trifloxysulfuron, metamifop and pyrazolynate and trifloxysulfuron, metamifop and benzofenap and trifloxysulfuron, metamifop and sulfentrazone and trifloxysulfuron, metamifop and pyraflufen-ethyl and trifloxysulfuron, metamifop and beflubutamid and trifloxysulfuron, metamifop and cafenstrole and trifloxysulfuron, metamifop and dimethametryn and trifloxysulfuron, metamifop and clomeprop and trifloxysulfuron, metamifop and prometryn and trifloxysulfuron, metamifop and benzobicyclon and trifloxysulfuron, metamifop and mesotrione and imazosulfuron, metamifop and sulcotrione and imazosulfuron, metamifop and isoxaflutole and imazosulfuron, metamifop and pyrazoxyfen and imazosulfuron, metamifop and pyrazolynate and imazosulfuron, metamifop and benzofenap and imazosulfuron, metamifop and sulfentrazone and imazosulfuron, metamifop and pyraflufen-ethyl and imazosulfuron, metamifop and beflubutamid and imazosulfuron, metamifop and cafenstrole and imazosulfuron, metamifop and dimethametryn and imazosulfuron, metamifop and clomeprop and imazosulfuron, metamifop and prometryn and imazosulfuron, metamifop and trifloxysulfuron and imazosulfuron, metamifop and benzobicyclon and imazosulfuron, metamifop and mesotrione and ethoxysulfuron, metamifop and sulcotrione and ethoxysulfuron, metamifop and isoxaflutole and ethoxysulfuron, metamifop and pyrazoxyfen and ethoxysulfuron, metamifop and pyrazolynate and ethoxysulfuron, metamifop and benzofenap and ethoxysulfuron, metamifop and sulfentrazone and ethoxysulfuron, metamifop and pyraflufen-ethyl and ethoxysulfuron, metamifop and beflubutamid and ethoxysulfuron, metamifop and cafenstrole and ethoxysulfuron, metamifop and dimethametryn and ethoxysulfuron, metamifop and clomeprop and ethoxysulfuron, metamifop and prometryn and ethoxysulfuron, metamifop and trifloxysulfuron and ethoxysulfuron, metamifop and benzobicyclon and ethoxysulfuron, metamifop and mesotrione and sulfosulfuron, metamifop and sulcotrione and sulfosulfuron, metamifop and isoxaflutole and sulfosulfuron, metamifop and pyrazoxyfen and sulfosulfuron, metamifop and pyrazolynate and sulfosulfuron, metamifop and benzofenap and sulfosulfuron, metamifop and sulfentrazone and sulfosulfuron, metamifop and pyraflufen-ethyl and sulfosulfuron, metamifop and beflubutamid and sulfosulfuron, metamifop and cafenstrole and sulfosulfuron, metamifop and dimethametryn and sulfosulfuron, metamifop and clomeprop and sulfosulfuron, metamifop and prometryn and sulfosulfuron, metamifop and trifloxysulfuron and sulfosulfuron, metamifop and benzobicyclon and sulfosulfuron, metamifop and mesotrione and iodosulfuron, metamifop and sulcotrione and iodosulfuron, metamifop and isoxaflutole and iodosulfuron, metamifop and pyrazoxyfen and iodosulfuron, metamifop and pyrazolynate and lodosulfuron, metamifop and benzofenap and iodosulfuron, metamifop and sulfentrazone and iodosulfuron, metamifop and pyraflufen-ethyl and iodosulfuron, metamifop and beflubutamid and iodosulfuron, metamifop and cafenstrole and iodosulfuron, metamifop and dimethametryn and iodosulfuron, metamifop and clomeprop and iodosulfuron, metamifop and prometryn and iodosulfuron, metamifop and trifloxysulfuron and iodosulfuron, metamifop and benzobicyclon and iodosulfuron, metamifop and mesotrione and mesosulfuron, metamifop and sulcotrione and mesosulfuron, metamifop and isoxaflutole and mesosulfuron, metamifop and pyrazoxyfen and mesosulfuron, metamifop and pyrazolynate and mesosulfuron, metamifop and benzofenap and mesosulfuron, metamifop and sulfentrazone and mesosulfuron, metamifop and pyraflufen-ethyl and mesosulfuron, metamifop and beflubutamid and mesosulfuron, metamifop and cafenstrole and mesosulfuron, metamifop and dimethametryn and mesosulfuron, metamifop and clomeprop and mesosulfuron, metamifop and prometryn and mesosulfuron, metamifop and trifloxysulfuron and mesosulfuron, metamifop and benzobicyclon and mesosulfuron, metamifop and mesotrione and tritosulfuron, metamifop and sulcotrione and tritosulfuron, metamifop and isoxaflutole and tritosulfuron, metamifop and pyrazoxyfen and tritosulfuron, metamifop and pyrazolynate and tritosulfuron, metamifop and benzofenap and tritosulfuron, metamifop and sulfentrazone and tritosulfuron, metamifop and pyraflufen-ethyl and tritosulfuron, metamifop and beflubutamid and tritosulfuron, metamifop and cafenstrole and tritosulfuron, metamifop and dimethametryn and tritosulfuron, metamifop and clomeprop and tritosulfuron, metamifop and prometryn and tritosulfuron, metamifop and trifloxysulfuron and tritosulfuron, metamifop and benzobicyclon and tritosulfuron, metamifop and mesotrione and N-[(4,6-dimethoxypyrimidin-2-yl)aminocarbonyl]-2-(2-fluoro-1-methoxy-acetoxy-n-propyl)-pyridine-3-sulfonamide, metamifop and sulcotrione and N-[(4,6-dimethoxypyrimidin-2-yl)-aminocarbonyl]-2-(2-fluoro-1-methoxy-acetoxy-n-propyl)pyridine-3-sulfonamide, metamifop and isoxaflutole and N-[(4,6-dimethoxypyrimidin-2-yl)aminocarbonyl]-2-(2-fluoro-1-methoxy-acetoxy-n-propyl)pyridine-3-sulfonamide, metamifop and pyrazoxyfen and N-[(4,6-dimethoxypyrimidin-2-yl)aminocarbonyl]-2-(2-fluoro-1-methoxy-acetoxy-n-propyl)pyridine-3-sulfonamide, metamifop and pyrazolynate and N-[(4,6-dimethoxypyrimidin-2-yl)amino-carbonyl]-2-(2-fluoro-1-methoxy-acetoxy-n-propyl)pyridine-3-sulfonamide, metamifop and benzofenap and N-[(4,6-dimethoxypyrimidin-2-yl)aminocarbonyl]-2-(2-fluoro-1-methoxy-acetoxy-n-propyl)pyridine-3-sulfonamide, metamifop and sulfentrazone and N-[(4,6-dimethoxypyrimidin-2-yl)aminocarbonyl]-2-(2-fluoro-1-methoxy-acetoxy-n-propyl)pyridine-3-sulfonamide, metamifop and pyraflufen-ethyl and N-[(4,6-dimethoxypyrimidin-2-yl)amino-carbonyl]-2-(2-fluoro-1-methoxy-acetoxy-n-propyl)pyridine-3-sulfonamide, metamifop and beflubutamid and N-[(4,6-dimethoxypyrimidin-2-yl)aminocarbonyl]-2-(2-fluoro-1-methoxy-acetoxy-n-propyl)pyridine-3-sulfonamide, metamifop and cafenstrole and N-[(4,6-dimethoxy-pyrimidin-2-yl)aminocarbonyl]-2-(2-fluoro-1-methoxy-acetoxy-n-propyl)pyridine-3-sulfon-amide, metamifop and dimethametryn and N-[(4,6-dimethoxypyrimidin-2-yl)aminocarbonyl]-2-(2-fluoro-1-methoxy-acetoxy-n-propyl)pyridine-3-sulfonamide, metamifop and clomeprop and N-[(4,6-dimethoxypyrimidin-2-yl)aminocarbonyl]-2-(2-fluoro-1-methoxy-acetoxy-n-propyl)pyridine-3-sulfonamide, metamifop and prometryn and N-[(4,6-dimethoxypyrimidin-2-yl)aminocarbonyl]-2-(2-fluoro-1-methoxy-acetoxy-n-propyl)pyridine-3-sulfonamide, metamifop and trifloxysulfuron and N-[(4,6-dimethoxypyrimidin-2-yl)aminocarbonyl]-2-(2-fluoro-1-methoxy-acetoxy-n-propyl)pyridine-3-sulfonamide, metamifop and benzobicyclon and N-[(4,6-dimethoxypyrimidin-2-yl)aminocarbonyl]-2-(2-fluoro-1-methoxy-acetoxy-n-propyl)pyridine-3-sulfonamide, metamifop and bentazone and trifloxysulfuron, metamifop and bentazone and ethoxysulfuron, metamifop and bentazone and mesosulfuron, metamifop and bentazone and N-[(4,6-dimethoxypyrimidin-2-yl)aminocarbonyl]-2-(2-fluoro-1-methoxy-acetoxy-n-propyl)pyridine-3-sulfonamide, metamifop and simetryn and cinosulfuron, metamifop and simetryn and triasulfuron, metamifop and simetryn and prosulfuron, metamifop and simetryn and trifloxysulfuron, metamifop and simetryn and imazosulfuron, metamifop and simetryn and ethoxysulfuron, metamifop and simetryn and sulfosulfuron, metamifop and simetryn and iodosulfuron, metamifop and simetryn and mesosulfuron, metamifop and simetryn and tritosulfuron, metamifop and simetryn and N-[(4,6-dimethoxy-pyrimidin-2-yl)aminocarbonyl]-2-(2-fluoro-1-methoxy-acetoxy-n-propyl)pyridine-3-sulfon-amide, and also metamifop and clodinafop and 2,4-D.

Compositions that have been found to be very especially effective are the combinations metamifop and acetochlor, metamifop and metolachlor, metamifop and S-metolachlor, metamifop and pyraclonil, metamifop and mesotrione.

The rate of application may vary within wide limits and depends on the nature of the soil, the method of application (pre- or post-emergence; seed dressing; application to the seed furrow; no tillage application etc.), the crop plant, the weed to be controlled, the prevailing climatic conditions, and other factors governed by the method of application, the time of application and the target crop. The active ingredient mixture according to the invention can generally be applied at a rate of from 0.001 to 1.5 kg of active ingredient mixture per hectare.

The mixtures according to the invention may be used in unmodified form, that is to say as obtained in synthesis. Preferably, however, they are formulated in customary manner, together with the adjuvants conventionally used in formulation technology, such as solvents, solid carriers or surfactants, for example into emulsifiable concentrates, directly sprayable or dilutable solutions, wettable powders, soluble powders, dusts, granules or microcapsules, as is described in WO 97/34483, pages 9 to 13. As with the nature of the compositions, the methods of application, such as spraying, atomising, dusting, wetting, scattering or pouring, are chosen in accordance with the intended objectives and the prevailing circumstances. The formulations, i.e. the compositions, preparations or products comprising the mixtures according to the invention, and also, where appropriate, one or more solid or liquid formulation adjuvants, are prepared in a manner known per se, e.g. by intimately mixing and/or grinding the active ingredients with the formulation adjuvants, e.g. solvents or solid carriers. In addition, surface-active compounds (surfactants) may also be used in the preparation of the formulations.

Examples of solvents and solid carriers are given, for example, in WO 97/34485, page 6. Depending on the nature of the active ingredients to be formulated, suitable surface-active compounds are non-ionic, cationic and/or anionic surfactants and surfactant mixtures having good emulsifying, dispersing and wetting properties. Examples of suitable anionic, non-ionic and cationic surfactants are listed, for example, in WO 97/34485, pages 7 and 8. Also suitable for the preparation of the herbicidal compositions according to the invention are the surfactants conventionally used in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol I-III, Chemical Publishing Co., New York, 1980-81.

The herbicidal formulations usually contain from 0.1 to 99% by weight, especially from 0.1 to 95% by weight, of active ingredient mixture, from 1 to 99.9% by weight of a solid or liquid formulation adjuvant, and from 0 to 25% by weight, especially from 0.1 to 25% by weight, of a surfactant.

Whereas the preferred commercial products are usually concentrates, the end user will normally employ dilute formulations. The compositions may also comprise further ingredients, such as stabilisers, e.g. vegetable oils or epoxidised vegetable oils (epoxidised coconut oil, rapeseed oil or soybean oil), antifoams, e.g. silicone oil, preservatives, viscosity regulators, binders, tackifiers, and also fertilisers or other active ingredients. Preferred formulations have especially the following compositions: (%=percent by weight)

Emulsifiable Concentrates:

active ingredient mixture: from 1 to 90%, preferably from 5 to 20%

surface-active agent: from 1 to 30%, preferably from 10 to 20%

liquid carrier: from 5 to 94%, preferably from 70 to 85%

Dusts:

active ingredient mixture: from 0.1 to 10%, preferably from 0.1 to 5%

solid carrier: from 99.9 to 90%, preferably from 99.9 to 99%

Suspension Concentrates:

active ingredient mixture: from 5 to 75%, preferably from 10 to 50%

water: from 94 to 24%, preferably from 88 to 30%

surface-active agent: from 1 to 40%, preferably from 2 to 30%

Wettable Powders:

active ingredient mixture: from 0.5 to 90%, preferably from 1 to 80%

surface-active agent: from 0.5 to 20%, preferably from 1 to 15%

solid carrier: from 5 to 95%, preferably from 15 to 90%

Granules:

active ingredient mixture: from 0.1 to 30%, preferably from 0.1 to 15%

solid carrier: from 99.5 to 70%, preferably from 97 to 85%

The Examples that follow illustrate the invention further. They do not limit the invention.

| | F1. Emulsifiable concentrates | | | |
|---|---|---|---|---|
| | a) | b) | c) | d) |
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| aromatic C₉-C₁₂ hydrocarbon mixture | 85% | 78% | 55% | 16% |

Emulsions of any desired concentration can be prepared from such concentrates by dilution with water.

| | F2. Solutions | | | |
|---|---|---|---|---|
| | a) | b) | c) | d) |
| active ingredient mixture | 5% | 10% | 50% | 90% |
| 1-methoxy-3-(3-methoxy-propoxy)-propane | — | 20% | 20% | — |
| polyethylene glycol (mol. wt. 400) | 20% | 10% | — | — |
| N-methyl-2-pyrrolidone | — | — | 30% | 10% |
| aromatic C₉-C₁₂ hydrocarbon mixture | 75% | 60% | — | — |

The solutions are suitable for application in the form of micro-drops.

| | F3. Wettable powders | | | |
|---|---|---|---|---|
| | a) | b) | c) | d) |
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalenesulfonate | — | 6% | 5% | 6% |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| | F4. Coated granules | | |
|---|---|---|---|
| | a) | b) | c) |
| active ingredient mixture | 0.1% | 5% | 15% |
| highly dispersed silicic acid | 0.9% | 2% | 2% |
| inorganic carrier material (diameter 0.1-1 mm) | 99.0% | 93% | 83% |
| for example CaCO₃ or SiO₂ | | | |

The active ingredient is dissolved in methylene chloride, the solution is sprayed onto the carrier, and the solvent is subsequently evaporated off in vacuo.

| | F5. Coated granules | | |
|---|---|---|---|
| | a) | b) | c) |
| active ingredient mixture | 0.1% | 5% | 15% |
| polyethylene glycol (mol. wt. 200) | 1.0% | 2% | 3% |
| highly dispersed silicic acid | 0.9% | 1% | 2% |
| inorganic carrier material (diameter 0.1-1 mm) | 98.0% | 92% | 80% |
| for example CaCO₃ or SiO₂ | | | |

The finely ground active ingredient is uniformly applied, in a mixer, to the carrier material moistened with polyethylene glycol, yielding non-dusty coated granules.

F6. Extruder granules

| | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed with the adjuvants, and the mixture is ground, moistened with water, extruded and then dried in a stream of air.

| | F7. Dusts | | |
|---|---|---|---|
| | a) | b) | c) |
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| | F8. Suspension concentrates | | | |
|---|---|---|---|---|
| | a) | b) | c) | d) |
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde solution | 0.2% | 0.2% | 0.2% | 0.2% |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical to formulate the active ingredients of the mixtures according to the invention separately and then, shortly before application, to bring them together in the applicator in the desired mixing ratio in the form of a “tank mixture” in water.

### BIOLOGICAL EXAMPLES:

### Example B1: Pre-Emergence Test:

The test plants are sown in pots under greenhouse conditions. A standard soil is used as cultivation substrate. At a pre-emergence stage, the herbicides, both on their own and in admixture, are applied to the surface of the soil. The rates of application depend on the optimum concentrations ascertained under field conditions or greenhouse conditions. The tests are evaluated after from 2 to 4 weeks (100% action=plant is completely dead; 0% action=no phytotoxic action). The mixtures used in this test show good results.

### Example B2: Post-Emergence Test:

The test plants are cultivated in pots under greenhouse conditions until a post-application stage. A standard soil is used as cultivation substrate. At a post-emergence stage, the herbicides, both on their own and in admixture, are applied to the test plants. The rates of application depend on the optimum concentrations ascertained under field conditions or greenhouse conditions. The tests are evaluated after from 2 to 4 weeks (100% action=plant is completely dead; 0% action=no phytotoxic action). The mixtures used in this test show good results.

What is claimed is:

1. A herbicidal synergistic composition comprising a mixture of
a) metamifop and
b) a synergistically effective amount of at least one compound selected from the compounds of the group mesotrione, sulcotrione, isoxaflutole, pyrazoxyfen, pyrazolynate, benzofenap, sulfentrazone, pyraflufen-ethyl, beflubutamid, cafenstrole, dimethametryn, clomeprop, prometryn, cinosulfuron, triasulfuron, prosulfuron, imazosulfuron, ethoxysulfuron, sulfosulfuron, iodosulfuron, tritosulfuron, mesosulfuron, trifloxysulfuron, benzobicyclon, acetochlor, metolachlor, S-metolachlor, pyraclonil and N-[(4,6-dimethoxypyrimidin-2-yl)aminocarbonyl]-2-(2-fluoro-1-methoxy-acetoxy-n-propyl)pyridine-3-sulfonamide, (bentazone and trifloxysulfuron), (bentazone and ethoxysulfuron), (bentazone and mesosulfuron), (bentazone and N-[(4,6-dimethoxypyrimidin-2-yl)aminocarbonyl]-2-(2-fluoro-1-methoxy-acetoxy-n-propyl)pyridine-3-sulfonamide), (simetryn and cinosulfuron), (simetryn and triasulfuron), (simetryn and prosulfuron), (simetryn and trifloxysulfuron), (simetryn and imazosulfuron), (simetryn and ethoxysulfuron), (simetryn and sulfosulfuron), (simetryn and iodosulfuron), (simetryn and mesosulfuron), (simetryn and tritosulfuron), (simetryn and N-[(4,6-dimethoxypyrimidin-2-yl)aminocarbonyl]-2-(2-fluoro-1-methoxy-acetoxy-n-propyl)pyridine-3-sulfonamide) and (clodinafop and 2,4-D), the two-component mixture of metamifop with benzobicyclon being excluded.

2. A herbicidal synergistic composition according to claim 1, comprising a mixture of
a) metamifop and
b) a synergistically effective amount of at least one compound selected from the compounds of the group mesotrione, sulcotrione, isoxaflutole, pyrazoxyfen, pyrazolynate, benzofenap, sulfentrazone, pyraflufen-ethyl, beflubutamid, cafenstrole, dimethametryn, clomeprop, prometryn, cinosulfuron, triasulfuron, prosulfuron, imazosulfuron, ethoxysulfuron, sulfosulfuron, iodosulfuron, tritosulfuron, mesosulfuron, trifloxysulfuron, benzobicyclon and N-[(4,6-dimethoxypyrimidin-2-yl)aminocarbonyl]-2-(2-fluoro-1-methoxy-acetoxy-n-propyl)pyridine-3-sulfonamide, (bentazone and trifloxysulfuron), (bentazone and ethoxysulfuron), (bentazone and mesosulfuron), (bentazone and N-[(4,6-dimethoxypyrimidin-2-yl)aminocarbonyl]-2-(2-fluoro-1-methoxy-acetoxy-n-propyl)pyridine-3-sulfonamide), (simetryn and cinosulfuron), (simetryn and triasulfuron), (simetryn and prosulfuron), (simetryn and trifloxysulfuron), (simetryn and imazosulfuron), (simetryn and ethoxysulfuron), (simetryn and sulfosulfuron), (simetryn and iodosulfuron), (simetryn and mesosulfuron), (simetryn and tritosulfuron), (simetryn and N-[(4,6-dimethoxypyrimidin-2-yl)aminocarbonyl]-2-(2-fluoro-1-methoxy-acetoxy-n-propyl)pyridine-3-sulfonamide) and (clodinafop and 2,4-D), the two-component mixture of metamifop with benzobicyclon being excluded.

3. A method of controlling undesired plant growth in crops of useful plants, which comprises allowing a herbicidally effective amount of a composition according to claim 1 to act on the crop plant or the locus thereof.

4. A method according to claim 3, wherein the crop plant is rice.
